(19) United States
(12) Patent Application Publication
(10) Pub. No.: US 2018/0027256 A1
(43) Pub. Date: Jan. 25, 2018

(54) VIDEO ENCODING DEVICE, VIDEO ENCODING METHOD, AND VIDEO ENCODING PROGRAM

(71) Applicant: NEC CORPORATION, Tokyo (JP)

(72) Inventors: Seiya SHIBATA, Tokyo (JP); Takayuki ISHIDA, Tokyo (JP); Keiichi CHONO, Tokyo (JP); Noriaki SUZUKI, Tokyo (JP); Eita KOBAYASHI, Tokyo (JP); Kenta TOKUMITSU, Tokyo (JP)

(73) Assignee: NEC CORPORATION, Tokyo (JP)

(21) Appl. No.: 15/541,068

(22) PCT Filed: Dec. 16, 2015
(86) PCT No.: PCT/JP2015/006271

§ 371 Date: Jun. 30, 2017

(30) Foreign Application Priority Data
Jan. 19, 2015 (JP) 2015-007562

(51) Int. Cl. H04N 19/52; H04N 19/176; H04N 19/96; H04N 19/142; H04N 19/14; H04N 19/159; H04N 19/124

(52) U.S. Cl. CPC H04N 19/52; H04N 19/159; H04N 19/176; H04N 19/124; H04N 19/142; H04N 19/14; H04N 19/96

(57) ABSTRACT

A video encoding device includes: an encoding parameter search unit for receiving input video and outputting an encoding parameter; an encoder for receiving the input video and the encoding parameter and performing encoding; a code amount control unit for deciding a block size enlargement parameter indicating at least a degree of enlargement, based on a target code amount and encoding status information; and a block size enlargement unit for enlarging a block size of the input video based on the block size enlargement parameter.

### TECHNICAL FIELD

The present invention relates to a video encoding device, video encoding method, and video encoding program for performing an encoding process for a unit based on a recursive quadtree structure.

### BACKGROUND ART

Non Patent Literature (NPL) 1 describes High Efficiency Video Coding (HEVC) which is a video coding system based on ITU-T Recommendation H.265.

In HEVC, each frame of digitized video is split into coding tree units (CTUs), and each CTU is encoded in raster scan order. Each CTU is split into coding units (CUs) and encoded, in a quadtree structure. Each CU is split into prediction units (PUs) and predicted. The prediction error of each CU is split into transform units (TUs) and frequency-transformed, in a quadtree structure. A CU of the largest size is referred to as a “largest CU” (largest coding unit: LCU), and a CU of the smallest size is referred to as a “smallest CU” (smallest coding unit: SCU).

Each CU is prediction-encoded by intra prediction or inter-frame prediction (inter prediction).

FIG. 19 is an explanatory diagram depicting an example of CU partitioning in the case where the CTU size is 64×64 (64 pixels×64 pixels). (A) of FIG. 19 depicts an example of the partitioning shape (hereafter also referred to as “block structure”), and (B) of FIG. 19 depicts the CU quadtree structure corresponding to the partitioning shape depicted in (A) of FIG. 19.

Each CU is split into TUs in a quadtree structure. The TU partitioning is performed in the same way as the CU partitioning depicted in (A) of FIG. 19.

FIG. 20 is an explanatory diagram depicting an example of PU partitioning of a CU. Note that (A) of FIG. 20 depicts an example of CU partitioning of a CTU.

In (B) of FIG. 20, the upper part depicts an example of PU partitioning in inter prediction, and the lower part depicts an example of PU partitioning in intra prediction. In inter prediction encoding, any of seven types of sizes, namely, the same size as the CU size (2N×2N), two types of symmetric rectangular partitioning (2N×N, N×2N), and four types of asymmetric rectangular partitioning (2N×nU, 2N×nD, nR×2N, nL×2N), is selectable. In intra prediction encoding, any of the same size as the CU size (2N×2N) and the size of splitting the CU size by 4 (N×N) is selectable. Here, N×N is selectable in the case where the CU is the minimum size.

In inter prediction encoding, a motion vector can be transmitted for each PU. Hence, the number of motion vectors per CTU varies depending on the CU quadtree structure. When the partitioning is finer, the number of motion vectors is greater and the motion vector code amount is greater.

In intra prediction encoding, the TU partitioning is sequentially performed starting from a PU which is a block having the same size as the CU or obtained by splitting the CU by 4. In inter prediction encoding, the TU partitioning is sequentially performed starting from the CU.

The following describes the structure and operation of a typical video encoding device that receives each frame of digitized video as an input image and outputs a bitstream, with reference to FIG. 21.

A video encoding device depicted in FIG. 21 includes an encoding parameter search unit 210 and an encoder 220. The encoder 220 includes a transformer 221, a quantizer 222, an entropy encoder 227, an inverse quantizer 223, an inverse transformer 224, a buffer 225, and a predictor 226.

The encoding parameter search unit 210 calculates the encoding cost for each of the CU quadtree structure/PU partitioning shape/TU quadtree structure of a CTU, the prediction mode of a CU, the intra prediction direction of an intra PU, and the motion vector of an inter PU, and compares the encoding costs to determine an encoding parameter. The encoding cost reflects a code amount-related value and an encoding distortion (correlated with image quality). As an example, the encoding parameter search unit 210 uses the following rate distortion (RD) cost.

Cost=D+λ·R.

Here, D is an encoding distortion, R is a code amount that also takes into account a transform coefficient, and λ is a Lagrange multiplier.

The encoding parameter search unit 210 decides the CU quadtree structure/PU partitioning shape/TU quadtree structure so as to enhance encoding efficiency according to image features, for each CTU.

The predictor 226 generates a prediction signal for the input image signal of the CU, based on the CU quadtree structure and PU partitioning shape decided by the encoding parameter search unit 210. The prediction signal is generated by intra prediction or inter prediction.

The transformer 221 frequency-transforms a prediction error image (prediction error signal) obtained by subtracting the prediction signal from the input image signal, based on the TU quadtree structure decided by the encoding parameter search unit 210. In the transform encoding of the prediction error signal, the transformer 221 uses an orthogonal transform of 4×4, 8×8, 16×16, or 32×32 block size based on frequency transform. In detail, for the 4×4 TUs of the luminance component of the CU which is intra-encoded or inter-encoded, the transformer 221 uses a discrete sine transform (DST) approximated by integer arithmetic (i.e. having integer accuracy). For the other TUs, the transformer 221 uses a discrete cosine transform (DCT) approximated by integer arithmetic (i.e. having integer accuracy) corresponding to the block size.

The quantizer 222 performs a quantization process using a quantization parameter Qp and a transform coefficient (orthogonal transform coefficient) cij supplied from the transformer 221 as input, to obtain a quantization coefficient qij. In detail, qij is calculated as follows.

qij=Int(cij/Qstep)

Qstep=(mij*2^{qbit})/(Qscale(Qp % 6))

qbit=25+(Qp/6)−(BitDepth−log₂(N).

Here, mij is a quantization weighting coefficient, Qscale is a quantization step coefficient, BitDepth is input image pixel bit accuracy, and N is orthogonal transform size. When Qp is greater, Qstep is greater, and the code amount of the resulting value qij is smaller.

The inverse quantizer 223 inverse-quantizes the quantization coefficient. The inverse transformer 224 inverse-transforms the inverse quantization result. The prediction signal is added to the prediction error image obtained by the inverse transform, and the result is supplied to the buffer 225. The buffer 225 stores the image as a reference image.

The video encoding device includes a code amount controller (not depicted). The code amount controller controls the encoding process so that the code amount as a result of encoding a frame to be currently encoded is a target code amount. For example, the code amount controller controls the code amount of the quantization coefficient qij by changing the quantization parameter Qp. The code amount controller may control the function of the encoding parameter search unit 210 (the decision of the CU quadtree structure/PU partitioning shape/TU quadtree structure) through Qp, by setting λ as a function of Qp.

Patent Literature (PTL) 1 discloses a code amount control technique when determining that the code amount exceeds the target code amount, which differs from the aforementioned code amount control. In detail, to keep the code amount from exceeding the target code amount, the code amount is reduced by transmitting only information indicating status as a copy of an encoded frame. The information indicating status as a copy is supplied by signaling only skip mode.

The skip mode is a mode indicating that the motion vector of a block to be encoded is the same as the motion vector of its adjacent block and the block includes no quantization coefficient of a prediction error signal. In other words, of a plurality of encoding modes provided by the video encoding system, the skip mode is a transmission mode of transmitting only information that the motion vector of the block to be encoded is the same as the motion vector of its spatially or temporally adjacent block.

FIG. 22 depicts an example of motion vector changes before and after setting the skip mode for all blocks other than the upper leftmost block from among eight blocks. In the example in (A) of FIG. 22, each block has a different motion vector before setting the skip mode. After setting the skip mode, on the other hand, all blocks have the same vector as the upper leftmost block, as depicted in (B) of FIG. 22. Moreover, when setting the skip mode for the upper leftmost block, too, its motion vector is 0. Thus, the use of the skip mode in the whole screen enables the transmission of information that there is no motion and there is no prediction error signal, that is, the image is a copy image of a reference image.

PTL 1 describes the use of the skip mode in the case where the transmission rate exceeds a predetermined value.

### CITATION LIST

### Patent Literature

PTL 1: Japanese Patent Application Laid-Open No. H6-303096

### Non Patent Literature

NPL 1: ITU-T Recommendation H.265 High efficiency video coding, April 2013

### SUMMARY OF INVENTION

### Technical Problem

For example in the case where video changes significantly (scene change), video that is hard to be encoded is input as an original image, or the selection of an encoding parameter such as a motion vector is not appropriate, there is a possibility that the target code amount is exceeded merely by the code amount of motion vectors used for inter-screen prediction. In such a case, the code amount control on the quantization coefficient by controlling the quantization parameter Qp alone is insufficient to achieve the target code amount, so that the motion vector code amount needs to be reduced.

The video encoding device described in PTL 1 forcibly uses the skip mode in the case where the transmission rate exceeds the predetermined value (corresponding to the target code amount), in order to reduce the motion vector code amount. By forcibly using the skip mode in the whole screen to transmit only the information that the motion vectors of all blocks are 0, that is, there is no motion, the transmitted code amount can be reduced.

However, in the case where the skip mode is used in the whole screen for video having motion, a still image is transmitted despite the video being actually a moving image. This causes image quality degradation.

The present invention has an object of providing a video encoding device, video encoding method, and video encoding program that can reduce image quality degradation associated with motion vector code amount reduction.

### Solution to Problem

A video encoding device according to the present invention is a video encoding device including: encoding parameter search means for receiving input video and outputting an encoding parameter; and encoding means for receiving the input video and the encoding parameter and performing encoding, and includes: code amount control means for deciding a block size enlargement parameter indicating at least a degree of enlargement, based on a target code amount and encoding status information; and block size enlarging means for enlarging a block size of the input video based on the block size enlargement parameter.

A video encoding method according to the present invention is a video encoding method for receiving input video and outputting an encoding parameter, and receiving the input video and the encoding parameter and performing encoding, and includes: deciding a block size enlargement parameter indicating at least a degree of enlargement, based on a target code amount and encoding status information; and enlarging a block size of the input video based on the block size enlargement parameter.

A video encoding program according to the present invention is a video encoding program for receiving input video and outputting an encoding parameter, and receiving the input video and the encoding parameter and performing encoding, and causes a computer to execute: a process of deciding a block size enlargement parameter indicating at least a degree of enlargement, based on a target code amount and encoding status information; and a process of enlarging a block size of the input video based on the block size enlargement parameter.

### Advantageous Effects of Invention

According to the present invention, it is possible to reduce image quality degradation associated with motion vector code amount reduction.

### BRIEF DESCRIPTION OF DRAWINGS

FIG. 1 is a block diagram depicting Exemplary Embodiment 1 of a video encoding device.

FIG. 2 is an explanatory diagram depicting a motion vector selection method.

FIG. 3 is an explanatory diagram depicting a mean vector of motion vectors.

FIG. 4 is a flowchart depicting the operation of the video encoding device.

FIG. 5 is a block diagram depicting a first example of the video encoding device in Exemplary Embodiment 1.

FIG. 6 is an explanatory diagram depicting an example of information stored in a parameter table.

FIG. 7 is a flowchart depicting a block size enlargement parameter selection method.

FIG. 8 is a block diagram depicting a second example of the video encoding device in Exemplary Embodiment 1.

FIG. 9 is a block diagram depicting Exemplary Embodiment 2 of a video encoding device.

FIG. 10 is a block diagram depicting a first example of the video encoding device in Exemplary Embodiment 2.

FIG. 11 is a block diagram depicting a second example of the video encoding device in Exemplary Embodiment 2.

FIG. 12 is a block diagram depicting a third example of the video encoding device in Exemplary Embodiment 2.

FIG. 13 is a block diagram depicting a fourth example of the video encoding device in Exemplary Embodiment 2.

FIG. 14 is a block diagram depicting a fifth example of the video encoding device in Exemplary Embodiment 2.

FIG. 15 is a block diagram depicting Exemplary Embodiment 3 of a video encoding device.

FIG. 16 is an explanatory diagram depicting motion vector changes before and after block enlargement.

FIG. 17 is a block diagram depicting an example of the structure of an information processing system capable of realizing the functions of the video encoding device according to the present invention.

FIG. 18 is a block diagram depicting main parts of the video encoding device according to the present invention.

FIG. 19 is an explanatory diagram depicting an example of CU partitioning in the case where the CTU size is 64×64.

FIG. 20 is an explanatory diagram depicting an example of PU partitioning of a CU.

FIG. 21 is a block diagram depicting a typical video encoding device.

FIG. 22 is an explanatory diagram depicting motion vector changes before and after setting skip mode.

### DESCRIPTION OF EMBODIMENT

### Exemplary Embodiment 1

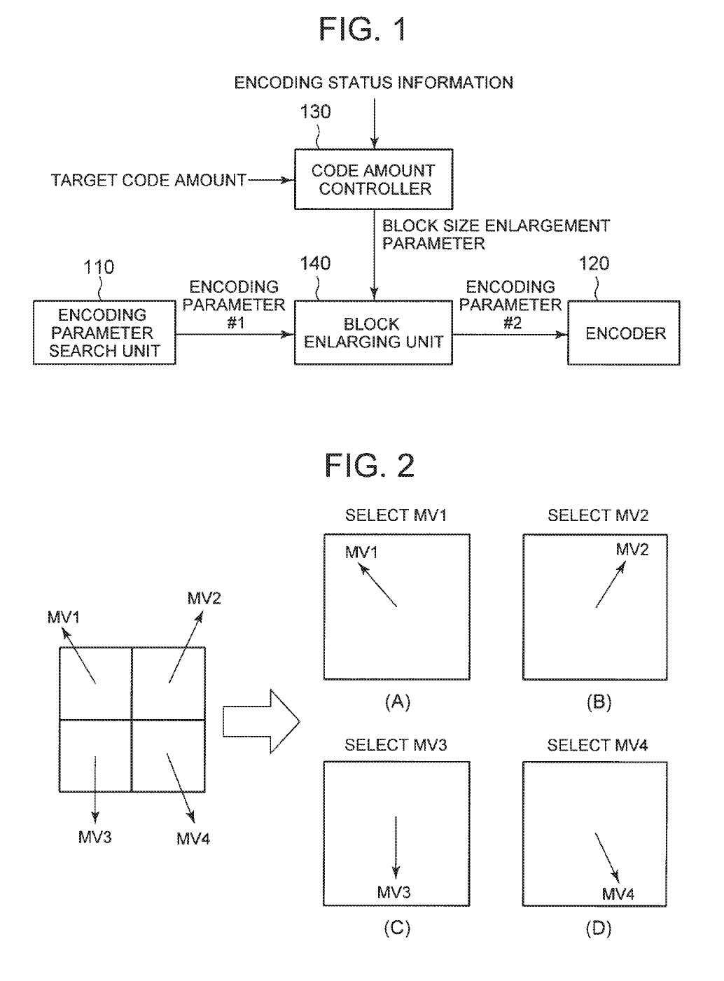

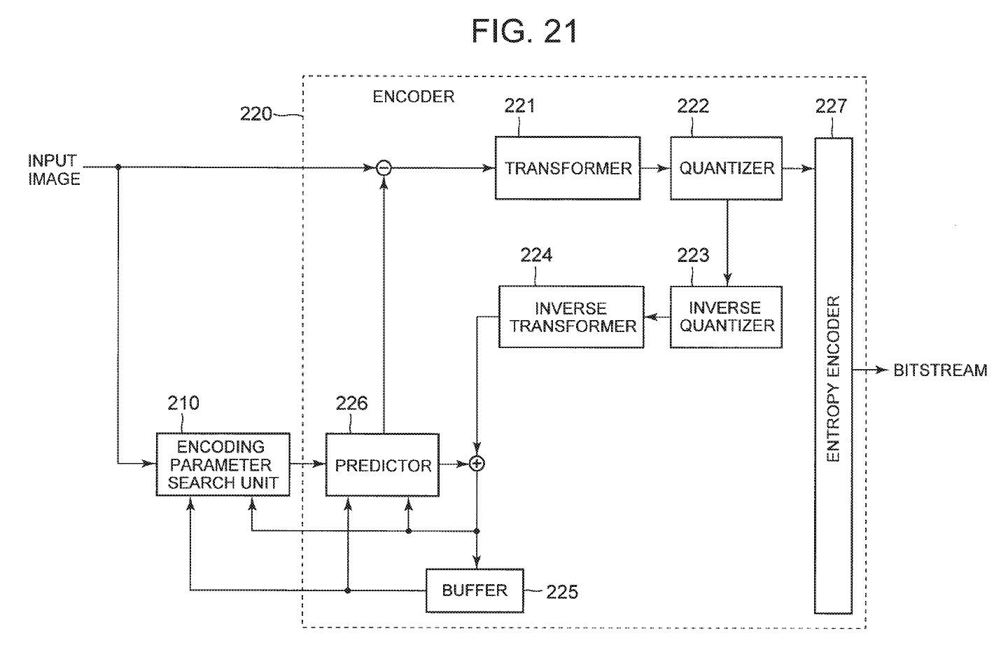

FIG. 1 is a block diagram depicting Exemplary Embodiment 1 of a video encoding device. The video encoding device depicted in FIG. 1 includes an encoding parameter search unit 110 for receiving input video and generating and outputting an encoding parameter, an encoder 120, a block enlarging unit 140, and a code amount controller 130. The encoder 120 has the same structure as the encoder 220 depicted in FIG. 21.

The block enlarging unit 140 receives the encoding parameter and a block size enlargement parameter, changes block partitioning and motion vector information in the encoding parameter, and outputs the result. The change method varies depending on the block size enlargement parameter. The output encoding parameter is supplied to the encoder 120.

The block size enlargement parameter can be roughly divided into the following three types of information:

(1) enlargement propriety determination condition;

(2) enlargement policy; and

(3) motion vector selection method upon enlargement.

“Enlargement propriety determination condition” is, for example, any of the following.

First condition: enlarge in the case where the four blocks corresponding to the child nodes of the quadtree structure all have the same size, the four blocks are all inter prediction blocks, and the four blocks are all PUs of 2N×2N (merge the plurality of blocks into one).

Second condition: enlarge in the case where the four blocks corresponding to the child nodes of the quadtree structure all have the same size and the four blocks are all inter prediction blocks, regardless of the PU size of the four blocks.

Third condition: enlarge in the case where the four blocks corresponding to the child nodes of the quadtree structure all have the same size, the four blocks are all PUs of 2N×2N, and not more than m (a predetermined natural number less than 4) blocks out of the four blocks are intra prediction blocks. In this case, one block obtained as a result of enlargement is an inter prediction block.

Fourth condition: enlarge in the case where the four blocks corresponding to the child nodes of the quadtree structure all have the same size and not more than m blocks out of the four blocks are intra prediction blocks, regardless of the PU size of the four blocks.

Here, m may be determined in any way. As an example, the code amount controller 130 sets m to the maximum value (3 in the aforementioned example) in the case where the code amount per unit time (bit rate) output from the encoder 120 exceeds or is likely to exceed a first threshold (an amount determined based on the target code amount and less than the target code amount), and sets m to be less than the maximum value in the case where the code amount per unit time exceeds or is likely to exceed a second threshold lower than the first threshold.

The code amount controller 130 may output all of the first to fourth conditions as the block size enlargement parameter of the enlargement propriety determination condition. Alternatively, the code amount controller 130 may change the block size enlargement parameter of the enlargement propriety determination condition depending on status (for example, the code amount per unit time output from the encoder 120). For example, the code amount controller 130 initially outputs only the first condition, and adds other condition(s) as the code amount per unit time increases.

Selecting each of the first to fourth conditions leads to the following state.

Regarding the first condition: for example, since the four blocks are merged into one block, the four motion vectors are represented by one motion vector. While image quality decreases, the code amount for representing the motion vectors is expected to be reduced to about ¼. Meanwhile, image quality degrades a little, although not to such an extent that renders video as a still image.

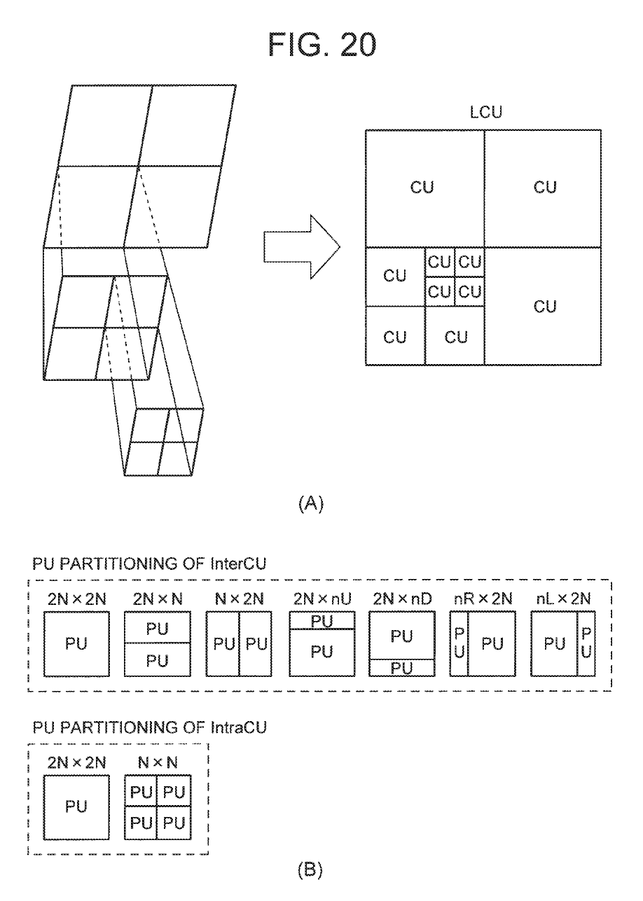

Regarding the second condition: for example, in the case where the four blocks includes any block (split into a plurality of PUs according to the PU partitioning depicted in the upper part of (B) of FIG. 20 which is not a 2N×2N block, the motion vectors of five or more PUs before the enlargement are represented by one motion vector. The code amount for representing the motion vectors is therefore expected to be reduced as compared with the case where the first condition is selected. Meanwhile, image quality degrades, although not to such an extent that renders video as a still image.

Regarding the third condition and the fourth condition: since merging into one inter prediction block is performed in the case where both inter prediction and intra prediction blocks coexist before enlargement, the code amount reduction effect is high. Meanwhile, image quality degrades more than in the case where the first condition or the second condition is selected, although not to such an extent that renders video as a still image.

The code amount controller 130 may use only part of the first to fourth conditions.

“Enlargement policy” is, for example, any of the following. “Enlargement policy” indicates the degree of enlargement.

0: not enlarge.

1: enlarge to a 1-level larger size.

2: enlarge to a 2-level larger size.

3: enlarge to a 3-level larger size.

4: enlarge all blocks smaller than 16×16 in size to 16×16.

5: enlarge all blocks smaller than 32×32 in size to 32×32.

6: enlarge all blocks smaller than 64×64 in size to 64×64.

Hereafter, not enlarging the block size is also referred to as the block size enlargement parameter being 0.

The code amount controller 130 may output any of the seven parameters as the block size enlargement parameter of the enlargement policy. As an example, the code amount controller 130 outputs the parameter “3” out of the aforementioned 1 to 3 or the parameter “6” out of the aforementioned 4 to 6, in the case where the code amount per unit time output from the encoder 120 exceeds or is likely to exceed a first threshold (an amount determined based on the target code amount and less than the target code amount).

The code amount controller 130 may use only part of the seven parameters.

“Motion vector selection method upon enlargement” is, for example, any of the following.

0: set the motion vector of the upper left block as the motion vector of the block after the enlargement (see (A) of FIG. 2).

1: set the motion vector of the upper right block as the motion vector of the block after the enlargement (see (B) of FIG. 2).

2: set the motion vector of the lower left block as the motion vector of the block after the enlargement (see (C) of FIG. 2).

3: set the motion vector of the lower right block as the motion vector of the block after the enlargement (see (D) of FIG. 2).

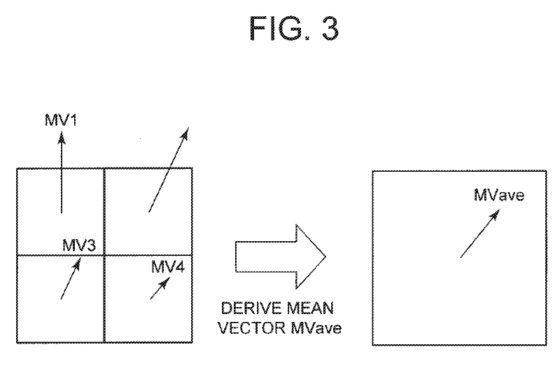

4: set the mean vector of the motion vectors of the four blocks as the motion vector of the block after the enlargement (see FIG. 3).

The code amount controller 130 may be configured to always output any of the five parameters, or change the parameter used depending on status (for example, the contents of the image).

The code amount controller 130 may use only part of the five parameters.

The code amount controller 130 receives the target code amount and code amount information (for example, the code amount per unit time output from the encoder 120), and outputs the block size enlargement parameter so that the code amount of the video to be currently encoded does not exceed the target code amount.

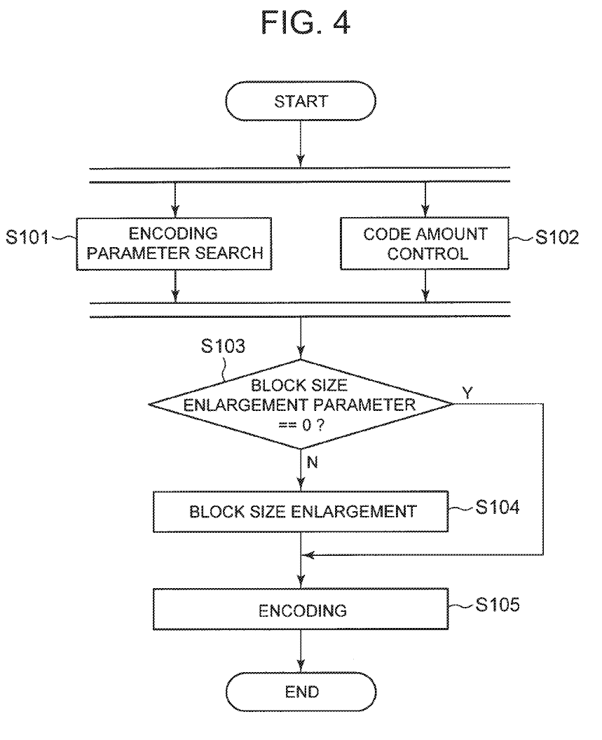

The following describes the operation of the video encoding device in this exemplary embodiment, with reference to a flowchart in FIG. 4.

When the encoding of an input image starts, first the encoding parameter search unit 110 performs block partitioning, searches an encoding mode and a prediction mode for each block, and decides encoding parameter #1 (step S101). For example, the encoding parameter search unit 110 decides an encoding parameter so as to increase RD cost, and outputs it as encoding parameter #1. Simultaneously, the code amount controller 130 decides a block size enlargement parameter based on the target code amount and encoding status information (step S102). The encoding status information is, for example, the bit rate of the code amount output from the encoder 120. The encoding status information is, however, not limited to the bit rate. The encoding status information may be any other information that allows the operation status of the encoder 120 (for example, bit rate increase status) to be recognized, as described later (see Exemplary Embodiment 2).

The code amount controller 130 outputs the block size enlargement parameter of each of the aforementioned “enlargement propriety determination condition”, “enlargement policy”, and “motion vector selection method upon enlargement”.

The block enlarging unit 140 then determines whether or not the block size enlargement parameter is 0, based on “enlargement policy” (step S103). In the case where the block size enlargement parameter is not 0, the block enlarging unit 140 modifies encoding parameter #1 obtained in step S102 and outputs encoding parameter #2, based on the block size enlargement parameter (step S104). In detail, the block enlarging unit 140 decides whether or not to perform block enlargement based on the condition (any of the first to fourth conditions) included in “enlargement propriety determination condition”. In the case of deciding to perform block enlargement, the block enlarging unit 140 decides the enlargement method according to “enlargement policy”, and sets “motion vector selection method upon enlargement” received from the code amount controller 130 as the motion vector decision method.

In the case where the block size enlargement parameter is 0, the block enlarging unit 140 does not modify encoding parameter #1, and sets encoding parameter #1 as encoding parameter #2. After this, the encoder 120 encodes the input image using encoding parameter #2 (step S105). Even in the case where “enlargement policy” is not “not enlarge” (=0), the block enlarging unit 140 does not modify encoding parameter #1 if “enlargement propriety determination condition” is not satisfied.

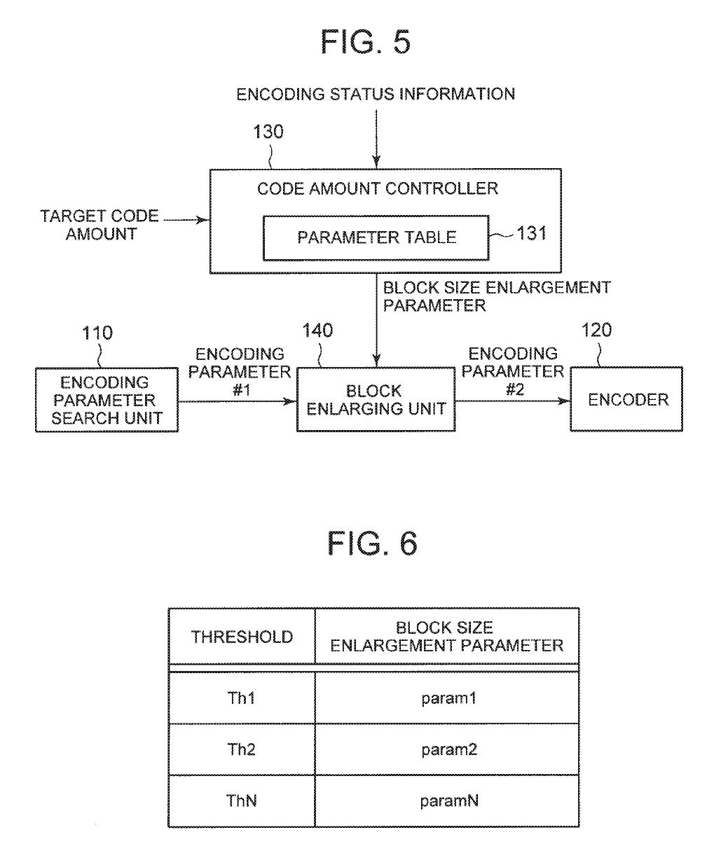

The following describes a specific example of the code amount controller 130. FIG. 5 is a block diagram depicting a first example of the video encoding device in Exemplary Embodiment 1. The code amount controller 130 depicted in FIG. 5 stores a parameter table 131 to output the block size enlargement parameter.

FIG. 6 depicts an example of information stored in the parameter table 131. In the example in FIG. 6, the parameter table 131 stores a plurality of pairs of thresholds and block size enlargement parameters (Th1 and param1, Th2 and param2, ThN and paramN). Each of param1, param2, and paramN includes the aforementioned “enlargement propriety determination condition”, “enlargement policy”, and “motion vector selection method upon enlargement” parameters.

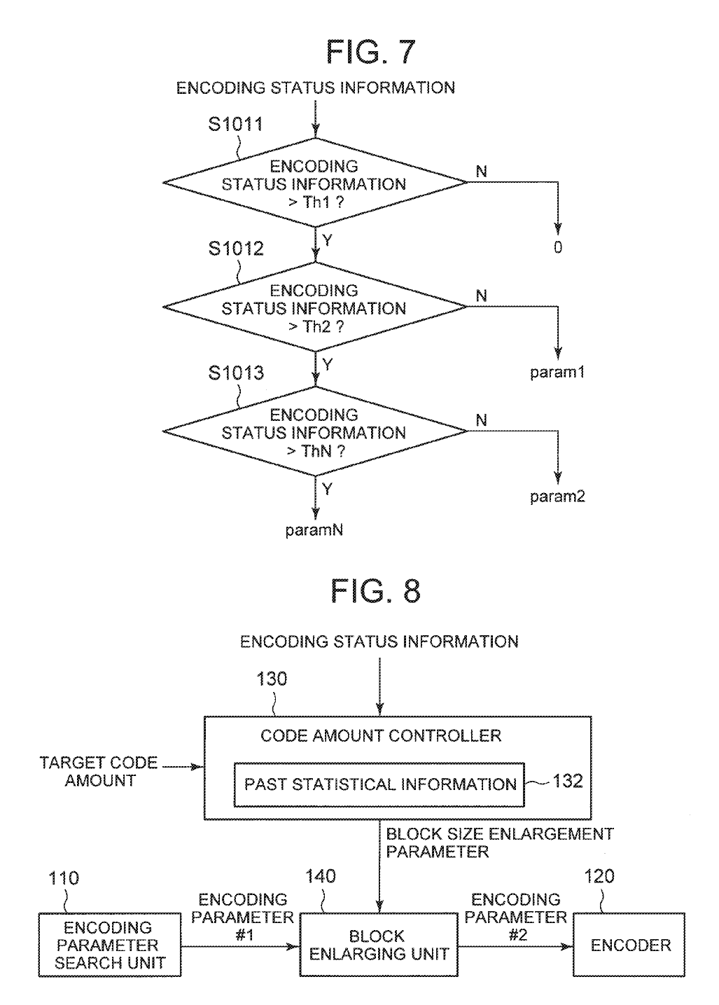

FIG. 7 is a flowchart depicting a block size enlargement parameter selection method. As depicted in FIG. 7, the code amount controller 130 outputs the block size enlargement parameter depending on whether or not the encoding status information exceeds the corresponding threshold.

In detail, when the value indicated by the encoding status information is less than a first threshold (Th1), the code amount controller 130 outputs data indicating “not enlarge” (=0) (step S1011). When the value indicated by the encoding status information is less than a second threshold (Th2), the code amount controller 130 outputs a first block size enlargement parameter (param1) (step S1012). When the value indicated by the encoding status information is less than a third threshold (ThN), the code amount controller 130 outputs a second block size enlargement parameter (param2) (step S1013). When the value indicated by the encoding status information is not less than the third threshold (ThN), the code amount controller 130 outputs an Nth block size enlargement parameter (paramN).

In this example, paramN includes a block size enlargement parameter that maximizes the code amount reduction effect. A parameter that increases the code amount reduction effect is, for example, such a parameter that corresponds to the enlargement to a larger size (regarding “enlargement policy”) or a higher possibility of selecting “enlarge” (regarding “enlargement propriety determination condition”).

The following describes a specific example of the encoding status information.

FIG. 8 is a block diagram depicting a second example of the video encoding device in Exemplary Embodiment 1. In the example in FIG. 8, the code amount controller 130 uses past statistical information 132 instead of the thresholds in the first example. The past statistical information 132 is statistical information (for example, a bit rate mean value) of encoding status information received in the past. The code amount controller 130 compares the past statistical information 132 and the current encoding status information to determine whether or not the code amount exceeds the target code amount. In the case of determining that the code amount exceeds the target code amount, the code amount controller 130 outputs a block size enlargement parameter that is not 0.

The code amount controller 130 may use both the past statistical information 132 and the parameter table 131 in the first example. As an example, the code amount controller 130 outputs the block size enlargement parameter based on the first example, in the case of determining that the code amount is likely to exceed the target code amount based on the past statistical information 132. Here, while the code amount controller 130 may output the data indicating “not enlarge” (=0) in the first example, the code amount controller 130 does not output the data indicating “not enlarge” (=0) in the second example. In the second example, a block size enlargement parameter that is not 0 is output in the case of determining that the code amount exceeds the target code amount.

### Exemplary Embodiment 2

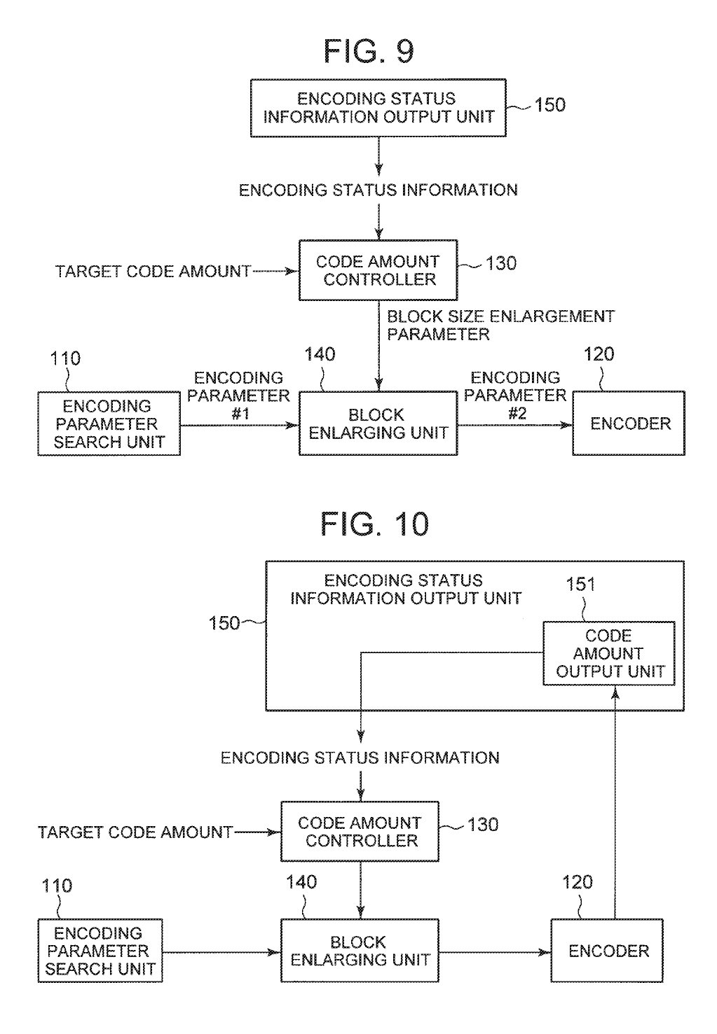

FIG. 9 is a block diagram depicting Exemplary Embodiment 2 of a video encoding device. FIG. 9 depicts an encoding status information output unit 150 for outputting encoding status information.

FIG. 10 is a block diagram depicting a first example of the video encoding device in Exemplary Embodiment 2. The encoding status information output unit 150 depicted in FIG. 10 includes a code amount output unit 151.

The encoding parameter search unit 110, the code amount controller 130, the block enlarging unit 140, and the encoder 120 operate in the same way as in Exemplary Embodiment 1.

The code amount output unit 151, each time the encoder 120 completes the encoding of a block or a picture, receives the encoded data amount (code amount) of the block or picture, and outputs the code amount as encoding status information.

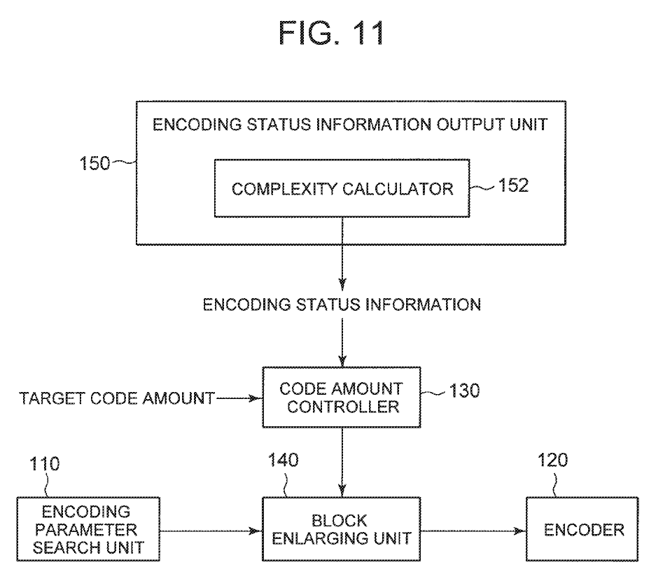

FIG. 11 is a block diagram depicting a second example of the video encoding device in Exemplary Embodiment 2. The encoding status information output unit 150 depicted in FIG. 11 includes a complexity calculator 152.

The encoding parameter search unit 110, the code amount controller 130, the block enlarging unit 140, and the encoder 120 operate in the same way as in Exemplary Embodiment 1.

The complexity calculator 152 analyzes input video, and outputs a feature value usable for the prediction of the code amount after encoding. As an example, the complexity calculator 152 calculates the pixel value variance in each block when splitting one frame into blocks of a predetermined size or calculates the pixel value variance in each block when splitting the difference frame between one frame and its preceding frame into blocks of a predetermined size, and outputs the calculated value as the feature value. The feature value thus indicates the level of difficulty in encoding the input video (the magnitude (large/small) of the code amount generated by the encoder 120).

The encoding status information output unit 150 outputs the feature value output from the complexity calculator 152, as encoding status information.

The code amount controller 130 predicts the code amount of the encoding result (i.e. encoded data) of the encoder 120, based on the encoding status information (feature value) output from the encoding status information output unit 150. The code amount controller 130 then determines whether or not the code amount exceeds the target code amount. In the case of determining that the code amount exceeds the target code amount, the code amount controller 130 outputs a block size enlargement parameter that is not 0.

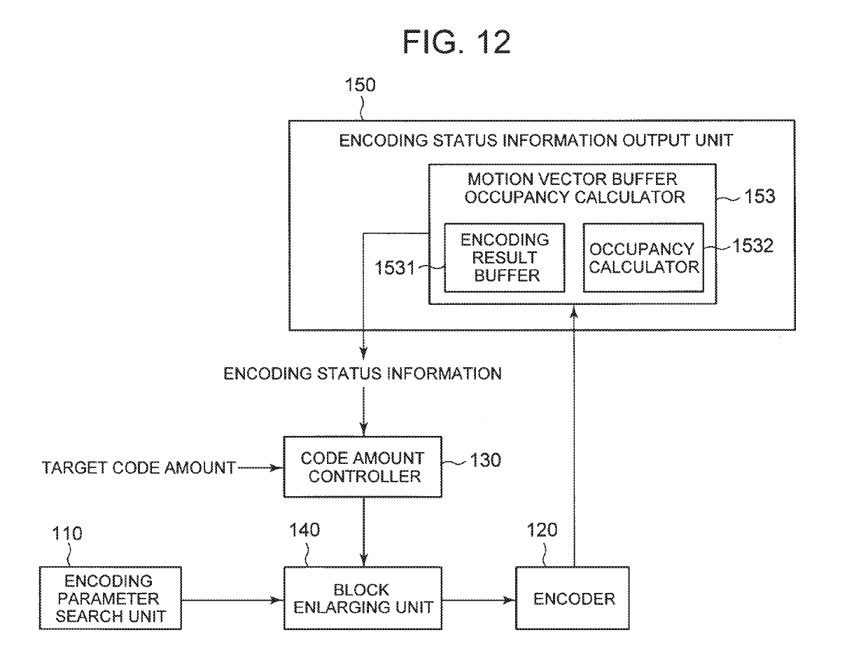

FIG. 12 is a block diagram depicting a third example of the video encoding device in Exemplary Embodiment 2. The encoding status information output unit 150 depicted in FIG. 12 includes a motion vector buffer occupancy calculator 153. The motion vector buffer occupancy calculator 153 includes an encoding result buffer 1531 and an occupancy calculator 1532.

The encoding parameter search unit 110, the code amount controller 130, the block enlarging unit 140, and the encoder 120 operate in the same way as in Exemplary Embodiment 1.

The motion vector buffer occupancy calculator 153 temporarily stores the encoding result (i.e. encoded data) of the encoder 120. The occupancy calculator 1532 calculates the ratio of occupancy of the motion vector code amount in the data amount (code amount) accumulated in the encoding result buffer 1531. The encoding status information output unit 150 outputs the ratio calculated by the occupancy calculator 1532, as encoding status information.

The code amount controller 130 outputs a block size enlargement parameter according to the control described in Exemplary Embodiment 1, based on the ratio as the encoding status information. In this example, the code amount controller 130 outputs such a block size enlargement parameter that produces a higher code amount reduction effect when the value indicated by the encoding status information (i.e. the ratio of occupancy of the motion vector code amount) is greater.

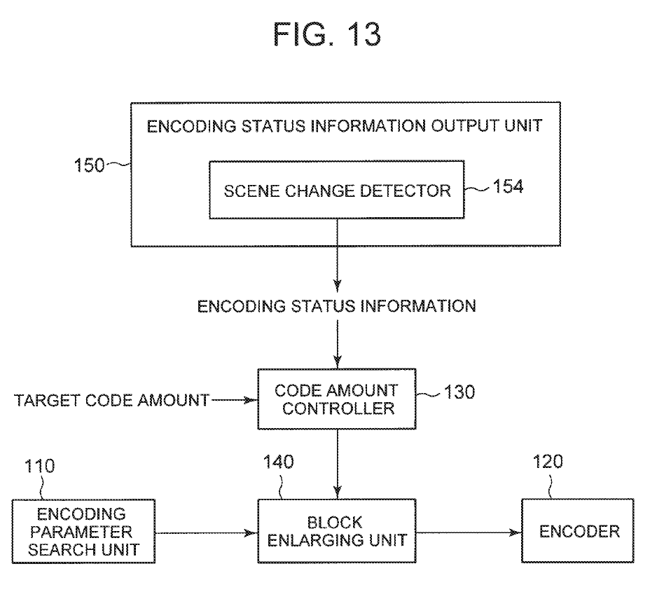

FIG. 13 is a block diagram depicting a fourth example of the video encoding device in Exemplary Embodiment 2. The encoding status information output unit 150 depicted in FIG. 13 includes a scene change detector 154.

The encoding parameter search unit 110, the code amount controller 130, the block enlarging unit 140, and the encoder 120 operate in the same way as in Exemplary Embodiment 1.

The scene change detector 154, upon detecting an abrupt change (scene change) of input video, outputs a scene change detection signal to the code amount controller 130 as encoding status information. While various scene change detection methods are available, basically the scene change detector 154 compares the feature values of consecutive frames and detects a frame having a significant change as a frame with a scene change.

The code amount controller 130, upon receiving the scene change detection signal, outputs a block size enlargement parameter according to the control described in Exemplary Embodiment 1. Here, while the code amount controller 130 can output a parameter selected from the plurality of block size enlargement parameters in Exemplary Embodiment 1, in this example the code amount controller 130 outputs the data indicating “not enlarge” (=0) when not receiving the scene change detection signal, and outputs, for example, a predetermined block size enlargement parameter when receiving the scene change detection signal.

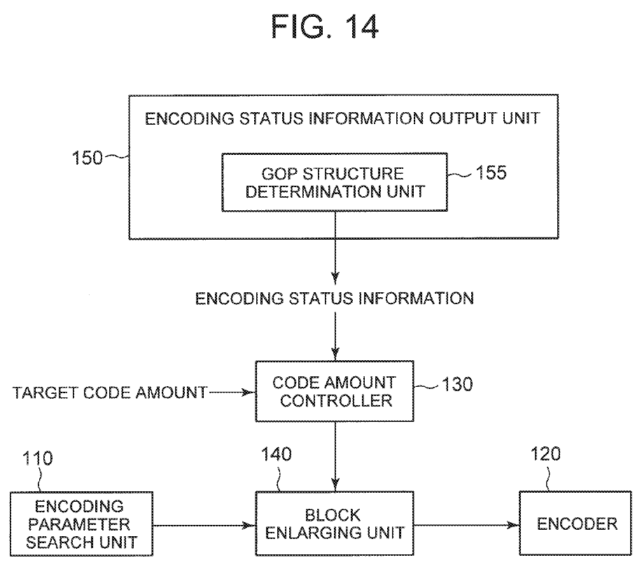

FIG. 14 is a block diagram depicting a fifth example of the video encoding device in Exemplary Embodiment 2. The encoding status information output unit 150 depicted in FIG. 14 includes a GOP (Group of Picture) structure determination unit 155. The GOP structure determination unit 155 may be provided outside the encoding status information output unit 150.

The encoding parameter search unit 110, the code amount controller 130, the block enlarging unit 140, and the encoder 120 operate in the same way as in Exemplary Embodiment 1.

The GOP structure determination unit 155 decides a picture group structure (GOP structure) in video encoding. When changing the group structure, the GOP structure determination unit 155 outputs data indicating that the GOP structure is changed and data indicating the changed GOP structure, as encoding status information.

The code amount controller 130, upon receiving the data indicating that the GOP structure is changed and the data indicating the changed GOP structure, outputs a block size enlargement parameter according to the control described in Exemplary Embodiment 1. For example, upon receiving the data indicating that the GOP structure is changed, the code amount controller 130 decides to output the data indicating “not enlarge” (=0), and decides which block size enlargement parameter is to output based on the data indicating the changed GOP structure.

Any one of the methods described as the first to fifth examples may be used, or any two or more of the methods may be used in combination.

### Exemplary Embodiment 3

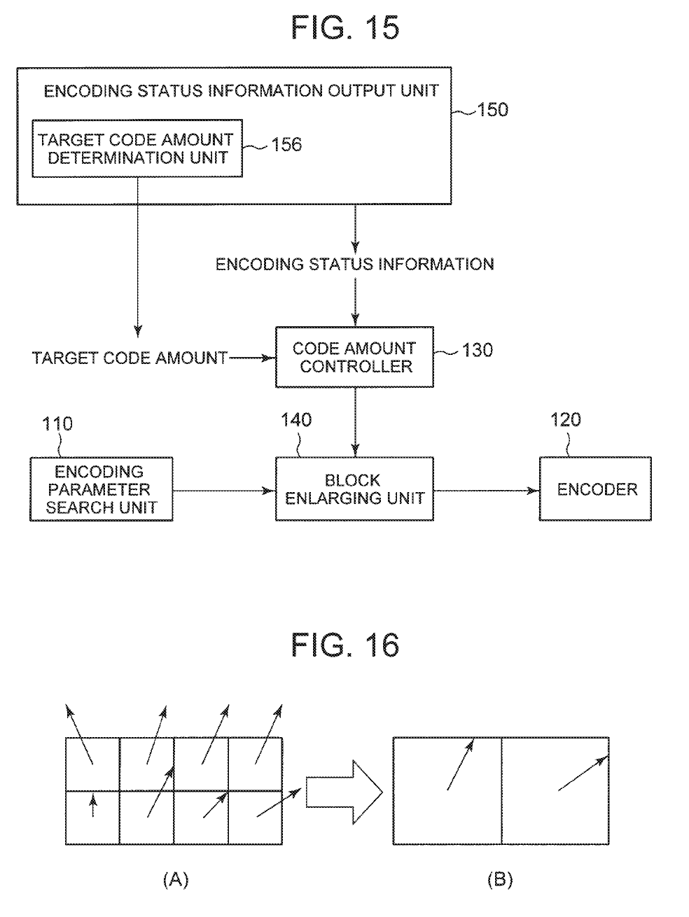

FIG. 15 is a block diagram depicting Exemplary Embodiment 3 of a video encoding device. In the video encoding device depicted in FIG. 15, the encoding status information output unit 150 includes a target code amount determination unit 156.

The encoding parameter search unit 110, the code amount controller 130, the block enlarging unit 140, and the encoder 120 operate in the same way as in Exemplary Embodiment 1.

The encoding status information output unit 150 may have a function of executing any one or more methods in the first to fifth examples in Exemplary Embodiment 2 (see FIGS. 10 to 14).

The target code amount determination unit 156, for example when the target code amount is changed, supplies the changed target code amount to the code amount controller 130. The timing with which the target code amount is changed is, for example, when the target code amount received from outside the video encoding device changes, when the period during which the past code amount in the code amount controller 130 does not exceed the set target code amount reaches a predetermined period or more, or when the frequency at which the past code amount in the code amount controller 130 exceeds the set target code amount exceeds a predetermined threshold.

The target code amount determination unit 156 may be configured to output data indicating that the target code amount is changed, as encoding status information. In this case, when the target code amount is changed, the code amount controller 130 decides which block size enlargement parameter is to output.

In the present invention, the block enlarging unit 140 and the encoder 120 operate according to the block size enlargement parameter output from the code amount controller 130. Hence, even in a situation where the code amount increases rapidly and is likely to exceed the target code amount, such video encoding that reduces the number of motion vectors to keep the coding amount from exceeding the target code amount can be performed. Block size enlargement enables the number of motion vectors to be reduced.

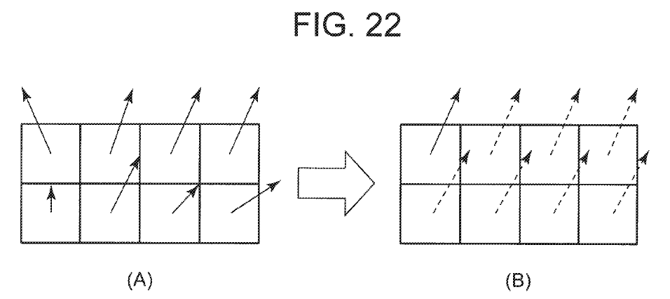

In the case of using the skip mode, the motion vectors of all blocks are in the same direction after setting the skip mode, which causes image quality degradation (see FIG. 22). According to the present invention, on the other hand, the motion vectors after block size enlargement are not always in the same direction, and motion information is maintained to a certain extent (see FIG. 16). Thus, image quality degradation can be reduced.

The video encoding device in each of the foregoing exemplary embodiments may be realized by hardware or a computer program.

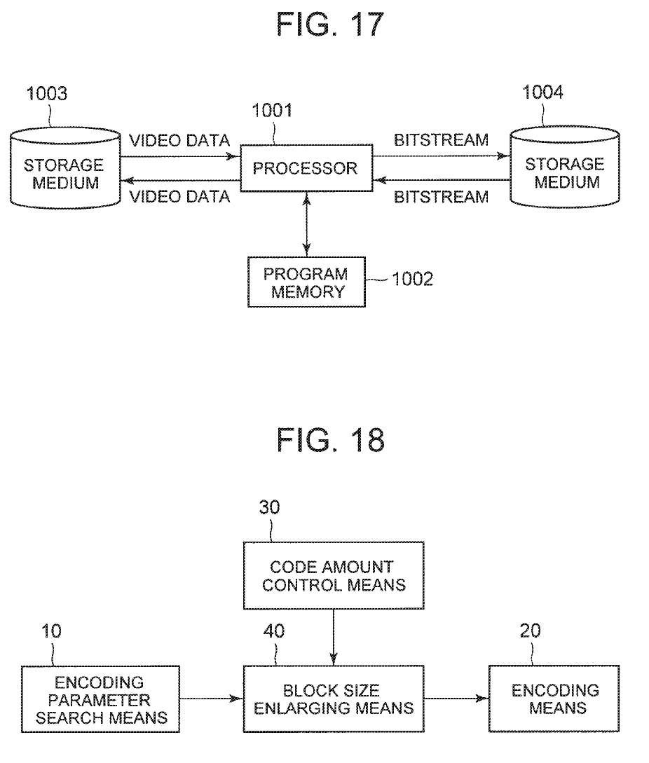

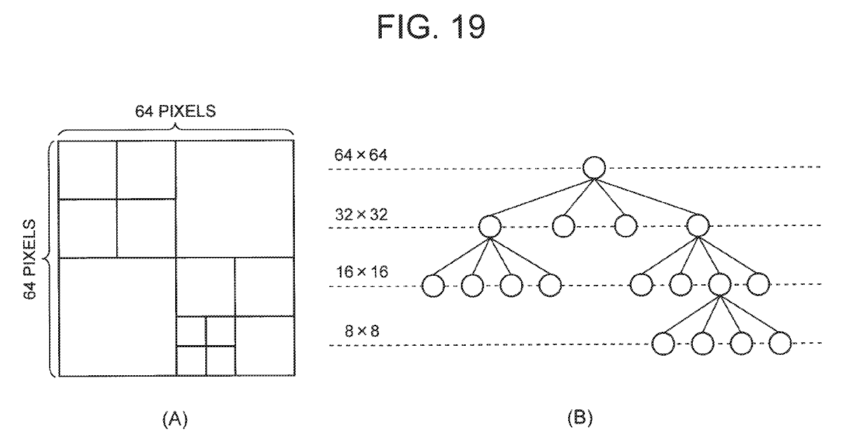

An information processing system depicted in FIG. 17 includes a processor 1001, program memory 1002, a storage medium 1003 for storing video data, and a storage medium 1004 for storing a bitstream. The storage medium 1003 and the storage medium 1004 may be separate storage media, or storage areas included in the same storage medium. A magnetic storage medium such as a hard disk may be used as a storage medium.

In the information processing system depicted in FIG. 17, a program for realizing the functions of the blocks (except the buffer block) in the video encoding device in each of the foregoing exemplary embodiments is stored in the program memory 1002. The processor 1001 realizes the functions of the video encoding device in each of the foregoing exemplary embodiments, by executing processes according to the program stored in the program memory 1002.

FIG. 18 is a block diagram depicting main parts of a video encoding device according to the present invention. As depicted in FIG. 18, the video encoding device is a video encoding device including: encoding parameter search means 10 (as an example, realized by the encoding parameter search unit 110 depicted in FIG. 1) for receiving input video and outputting an encoding parameter; and encoding means 20 (as an example, realized by the encoder 120 depicted in FIG. 1) for receiving the input video and the encoding parameter and performing encoding, and includes: code amount control means 30 (as an example, realized by the code amount controller 130 depicted in FIG. 1) for deciding a block size enlargement parameter indicating at least a degree of enlargement, based on a target code amount and encoding status information; and block size enlargement means 40 (as an example, realized by the block enlarging unit 140 depicted in FIG. 1) for enlarging a block size of the input video based on the block size enlargement parameter.

The video encoding device may include a parameter table (corresponding to the parameter table 131 depicted in FIG. 5) storing a plurality of pairs of encoding status information-related thresholds and block size enlargement parameters, wherein the code amount control means 30 selects the block size enlargement parameter depending on a result of comparison between a value indicated by the encoding status information received and a threshold, from the parameter table.

The code amount control means 30 may select the block size enlargement parameter depending on a result of comparison between a value indicated by the encoding status information received and statistical information of encoding status information received in past.

The video encoding device may include code amount output means (corresponding to the code amount output unit 151 depicted in FIG. 10) for outputting a code amount of encoded data as the encoding status information.

The video encoding device may include complexity calculation means (corresponding to the complexity calculator 152 depicted in FIG. 11) for analyzing the input video, calculating a feature value usable for prediction of a code amount after the encoding, and outputting the feature value as the encoding status information

The video encoding device may include occupancy calculation means (corresponding to the occupancy calculator 1532 depicted in FIG. 12) for calculating a ratio of occupancy of a motion vector code amount in a code amount of encoded data, and outputting the ratio as the encoding status information.

The video encoding device may include scene change detection means (corresponding to the scene change detector 154 depicted in FIG. 13) for, upon detecting a scene change of the input video, outputting a scene change detection signal as the encoding status information.

The video encoding device may include GOP structure determination means (corresponding to the GOP structure determination unit 155 depicted in FIG. 14) for, when a GOP is changed, outputting data indicating a changed GOP structure as the encoding status information.

The present invention is applicable to a video compression device at a constant bit rate or a program for realizing video compression at a constant bit rate on a computer. The present invention is also applicable to a video compression device at a variable bit rate with a bit rate upper limit, and a program for realizing video compression at a variable bit rate with a bit rate upper limit on a computer.

The foregoing exemplary embodiments may be partly or wholly described in the following supplementary notes, although the structure of the present invention is not limited to such.

(Supplementary note 1) A video encoding device including: encoding parameter search means for receiving input video and outputting an encoding parameter; and encoding means for receiving the input video and the encoding parameter and performing encoding, the video encoding device including: code amount control means for deciding a block size enlargement parameter indicating at least a degree of enlargement, based on a target code amount and encoding status information; and block size enlargement means for enlarging a block size of the input video based on the block size enlargement parameter, wherein the encoding status information is a notification that a target code amount signal is changed.

(Supplementary note 2) A video encoding device including: encoding parameter search means for receiving input video and outputting an encoding parameter; and encoding means for receiving the input video and the encoding parameter and performing encoding, the video encoding device including: code amount control means for deciding a block size enlargement parameter indicating at least a degree of enlargement, based on a target code amount and encoding status information; and block size enlargement means for enlarging a block size of the input video based on the block size enlargement parameter, wherein the block size enlargement means supplies a block size enlargement propriety determination condition as the block size enlargement parameter.

(Supplementary note 3) A video encoding device including: encoding parameter search means for receiving input video and outputting an encoding parameter; and encoding means for receiving the input video and the encoding parameter and performing encoding, the video encoding device including: code amount control means for deciding a block size enlargement parameter indicating at least a degree of enlargement, based on a target code amount and encoding status information; and block size enlargement means for enlarging a block size of the input video based on the block size enlargement parameter, wherein the block size enlargement means supplies a block size enlargement policy as the block size enlargement parameter.

(Supplementary note 4) A video encoding device including: encoding parameter search means for receiving input video and outputting an encoding parameter; and encoding means for receiving the input video and the encoding parameter and performing encoding, the video encoding device including: code amount control means for deciding a block size enlargement parameter indicating at least a degree of enlargement, based on a target code amount and encoding status information; and block size enlargement means for enlarging a block size of the input video based on the block size enlargement parameter, wherein the block size enlargement means supplies a motion vector selection method upon block size enlargement as the block size enlargement parameter.

Although the present invention has been described with reference to the above exemplary embodiments and examples, the present invention is not limited to the above exemplary embodiments and examples. Various changes understandable by those skilled in the art can be made to the structures and details of the present invention within the scope of the present invention.

This application claims priority based on Japanese Patent Application No. 2015-007562 filed on Jan. 19, 2015, the disclosure of which is incorporated herein in its entirety.

### REFERENCE SIGNS LIST

10 encoding parameter search means

20 encoding means

30 code amount control means

40 block size enlargement means

110 encoding parameter search unit

120 encoder

130 code amount controller

131 parameter table

132 past statistical information

140 block enlarging unit

150 encoding status information output unit

151 code amount output unit

152 complexity calculator

153 motion vector buffer occupancy calculator

1531 encoding result buffer

1532 occupancy calculator

154 scene change detector

155 GOP structure determination unit

156 target code amount determination unit

210 encoding parameter search unit

220 encoder

221 transformer

222 quantizer

223 inverse quantizer

224 inverse transformer

225 buffer

226 predictor

227 entropy encoder

1001 processor

1002 program memory

1003 storage medium

1004 storage medium

1. A video encoding device comprising:
a memory storing instructions; and
one or processors configured to execute the instructions to:
receive input video and output an encoding parameter;
receive the input video and the encoding parameter and perform encoding,
decide a block size enlargement parameter indicating at least a degree of enlargement, based on a target code amount and encoding status information; and
enlarge a block size of the input video based on the block size enlargement parameter.

2. The video encoding device according to claim 1, further comprising:
a parameter table storing a plurality of pairs of encoding status information-related thresholds and block size enlargement parameters,
wherein the one or processors configured to execute the instructions to select the block size enlargement parameter depending on a result of comparison between a value indicated by the encoding status information received and a threshold, from the parameter table.

3. The video encoding device according to claim 1,
wherein the one or processors configured to execute the instructions to select the block size enlargement parameter depending on a result of comparison between a value indicated by the encoding status information received and statistical information of encoding status information received in past.

4. The video encoding device according to claim 1,
wherein the one or processors further configured to execute the instructions to output a code amount of encoded data as the encoding status information.

5. The video encoding device according to claim 1,
wherein the one or processors further configured to execute the instructions to analyze the input video, calculate a feature value usable for prediction of a code amount after the encoding, and output the feature value as the encoding status information.

6. The video encoding device according to claim 1,
wherein the one or processors further configured to execute the instructions to calculate a ratio of occupancy of a motion vector code amount in a code amount of encoded data, and output the ratio as the encoding status information.

7. The video encoding device according to claim 1,
wherein the one or processors further configured to execute the instructions to upon detecting a scene change of the input video, output a scene change detection signal as the encoding status information.

8. The video encoding device according to claim 1,
wherein the one or processors further configured to execute the instructions to, when a GOP is changed, output data indicating a changed GOP structure as the encoding status information.

9. A video encoding method, implemented by a processor, comprising:
receiving input video and outputting an encoding parameter,
receiving the input video and the encoding parameter and performing encoding,
deciding a block size enlargement parameter indicating at least a degree of enlargement, based on a target code amount and encoding status information; and
enlarging a block size of the input video based on the block size enlargement parameter.

10. A non-transitory computer readable information recording medium storing a video encoding program, when executed by a processor, performs:
receiving input video and outputting an encoding parameter,
receiving the input video and the encoding parameter and performing encoding,
deciding a block size enlargement parameter indicating at least a degree of enlargement, based on a target code amount and encoding status information; and
enlarging a block size of the input video based on the block size enlargement parameter.

11. The video encoding device according to claim 2,
wherein the one or processors further configured to execute the instructions to output a code amount of encoded data as the encoding status information.

12. The video encoding device according to claim 2,
wherein the one or processors further configured to execute the instructions to analyze the input video, calculate a feature value usable for prediction of a code amount after the encoding, and output the feature value as the encoding status information.

13. The video encoding device according to claim 2,
wherein the one or processors further configured to execute the instructions to calculate a ratio of occupancy of a motion vector code amount in a code amount of encoded data, and output the ratio as the encoding status information.

14. The video encoding device according to claim 2,
wherein the one or processors further configured to execute the instructions to, upon detecting a scene change of the input video, output a scene change detection signal as the encoding status information.

15. The video encoding device according to claim 2,
wherein the one or processors further configured to execute the instructions to, when a GOP is changed, output data indicating a changed GOP structure as the encoding status information.

16. The video encoding device according to claim 3,
wherein the one or processors further configured to execute the instructions to output a code amount of encoded data as the encoding status information.

17. The video encoding device according to claim 3,
wherein the one or processors further configured to execute the instructions to analyze the input video, calculate a feature value usable for prediction of a code amount after the encoding, and output the feature value as the encoding status information.

18. The video encoding device according to claim 3,
wherein the one or processors further configured to execute the instructions to calculate a ratio of occupancy of a motion vector code amount in a code amount of encoded data, and output the ratio as the encoding status information.

19. The video encoding device according to claim 3,
wherein the one or processors further configured to execute the instructions to, upon detecting a scene change of the input video, output a scene change detection signal as the encoding status information.

20. The video encoding device according to claim 3,
wherein the one or processors further configured to execute the instructions to, when a GOP is changed, output data indicating a changed GOP structure as the encoding status information.
